(19) United States
(12) Patent Application Publication
(10) Pub. No.: US 2008/0000653 A1
(43) Pub. Date: Jan. 3, 2008

(54) Landscaping attachment

(76) Inventor: Scot M. Schwartz, Goodells, MI (US)

Correspondence Address: LITMAN LAW OFFICES, LTD., P.O. BOX 15035, CRYSTAL CITY STATION, ARLINGTON, VA, 22215, US

(21) Appl. No.: 11/808,239

(22) Filed: Jun. 7, 2007

Related U.S. Application Data
(60) Provisional application No. 60/811,409, filed on Jun. 7, 2006.

(51) Int. Cl. A01B 49/02

(52) U.S. Cl. 172/198

(57) ABSTRACT

The landscaping attachment is an earthworking or cultivating implement configured for towing behind a relatively small vehicle, e.g., a small all terrain vehicle or garden tractor. The attachment includes adjustably positionable wheels which may be lowered to lift the implement above the surface, or lifted to place the implement on the surface. Wheel operation is by electric power. The wheels may be optionally positioned or relocated to the front or rear of the implement. The implement may comprise an I-beam scraper having a series of teeth cut into the front flange. Alternatively, the teeth may be individually replaceable units. The implement may include angularly adjustable wings extending from each end thereof.

### CROSS-REFERENCE TO RELATED APPLICATION

This application claims the benefit of U.S. Provisional Patent Application Ser. No. 60/811,409, filed Jun. 7, 2006.

### BACKGROUND OF THE INVENTION

1. Field of the Invention

The present invention relates generally to earthworking and cultivation equipment. More specifically, the present invention relates to a landscaping attachment for pulling behind a small all-terrain vehicle (ATV), garden tractor, or the like.

2. Description of the Related Art

The need to level, cultivate, and otherwise shape and reconfigure the surface of various areas is a common occurrence in a number of different fields. Most such projects are relatively large scale, e.g., highway construction, site preparation for large building projects, etc., with large, self propelled machines such as graders, scrapers, levelers, etc. being used.

However, there are many times when smaller scale earthworking or cultivation projects arise, e.g., preparing a driveway for surfacing, smoothing ruts in an unpaved driveway or other limited area, smoothing sand traps and similar areas on golf courses, etc. Generally, the cost to transport a large scale, specialized machine to the site for such work and to operate the machine for such a relatively small job is prohibitive. The only recourse is time-consuming hand labor for such relatively small areas in the absence of suitable smaller scale equipment.

As a result, there has been some development of smaller scale earthworking equipment in the past. Most such equipment is configured for towing behind a full size tractor, rather than behind an ATV, garden or lawn tractor, or the like. Full size tractors and the like nearly universally include an engine driven hydraulic pump for providing hydraulic power to various accessories, e.g., front end or back end loaders and shovels, etc. Smaller all-terrain vehicles and garden tractors generally do not have such provision for hydraulic power.

Thus a landscaping attachment solving the aforementioned problems is desired.

### SUMMARY OF THE INVENTION

The landscaping attachment is an earthworking or cultivating implement, e.g., a scraper or the like, having a forwardly disposed hitch bar for removable attachment to a small towing vehicle, e.g., a small all-terrain vehicle, garden tractor, etc. The implement may be supported clear of the underlying surface by a pair of wheels, which may be selectively lowered or raised as desired. The raising and lowering of the wheels is accomplished by an electrical mechanism.

The wheel assembly may be relocated from the front to the rear of the earthworking implement, as desired. Positioning the wheels rearward of the implement may provide certain advantages, e.g., a longer wheelbase for the assembly and slightly greater weight transfer to the implement when the wheels are raised. However, it may be preferable to reposition the wheels to the front of the implement, as this permits the implement to erase all traces of the wheel tracks where the wheels are in contact with the surface and supporting some of the weight of the implement as the implement is dragged behind. The operator of the attachment may select the location of the wheels as desired, and reposition the wheel assembly accordingly.

The earthworking or cultivating implement of the landscaping attachment has various configurations. In one embodiment, the implement may be formed from a length of I-beam structural steel, with a forwardly disposed flange reconfigured to provide a series of teeth therealong. In another embodiment, the teeth may be replaceable teeth. The implement may also include angularly adjustable wings, which may be positioned at some forward angle relative to the main body of the implement or as a straight lateral extension of the implement.

These and other features of the present invention will become readily apparent upon further review of the following specification and drawings.

### BRIEF DESCRIPTION OF THE DRAWINGS

FIG. 1 is an environmental, perspective view of a first embodiment of a landscaping attachment according to the present invention being pulled behind a small all-terrain vehicle.

FIG. 2 is a right side view of the rear portion of the landscaping attachment of the present invention, showing the general geometry and operation of the trailing wheel configuration for the device.

FIG. 3 is a right side view of the rear portion of the landscaping attachment of the present invention, showing the general geometry and operation of the leading wheel configuration for the device.

FIG. 4 is a top perspective view of the landscaping attachment according to the present invention, showing further detail of the attachment of the wheel carriage assembly in the trailing configuration.

FIG. 5 is a perspective view of the landscaping attachment according to the present invention as seen from the right side, showing the lifting and lowering mechanism of the device and various details thereof.

FIG. 6 is a top plan view of the left side wing of the scraper or grader arm, showing the angular adjustability thereof.

FIG. 7 is a perspective view of an alternative embodiment of a landscaping attachment according to the present invention, the leading edge of the grader or scraper arm having replaceable teeth extending therefrom.

Similar reference characters denote corresponding features consistently throughout the attached drawings.

### DETAILED DESCRIPTION OF THE PREFERRED EMBODIMENTS

The present invention relates is a landscaping attachment for towing behind a light vehicle, e.g., garden tractor or all terrain vehicle, etc. The landscaping attachment includes an electrically powered lifting and lowering mechanism, which is particularly adaptable for use with such light towing vehicles, as such vehicles generally do not have hydraulic power for accessories.

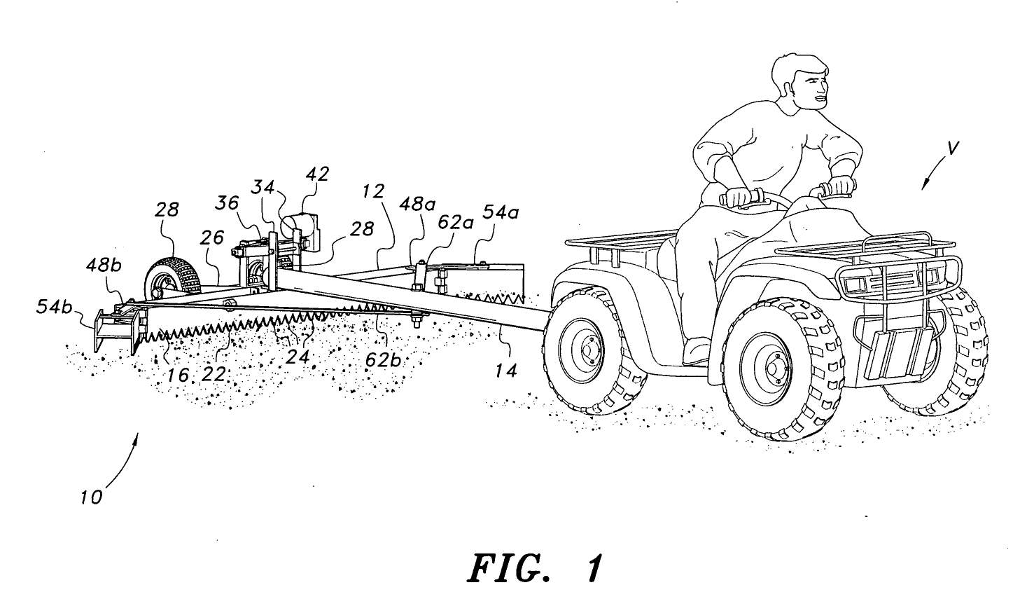

FIG. 1 of the drawings provides an environmental perspective view of the landscaping attachment 10 being towed behind a small all terrain vehicle V. The attachment 10 may comprise a variety of different implements providing different functions, but the attachment 10 shown in FIG. 1 is an elongate earthworking implement 12 having a towing tongue 14 attached to the medial portion thereof, and extending substantially normal to the length or span of the earthworking implement 12.

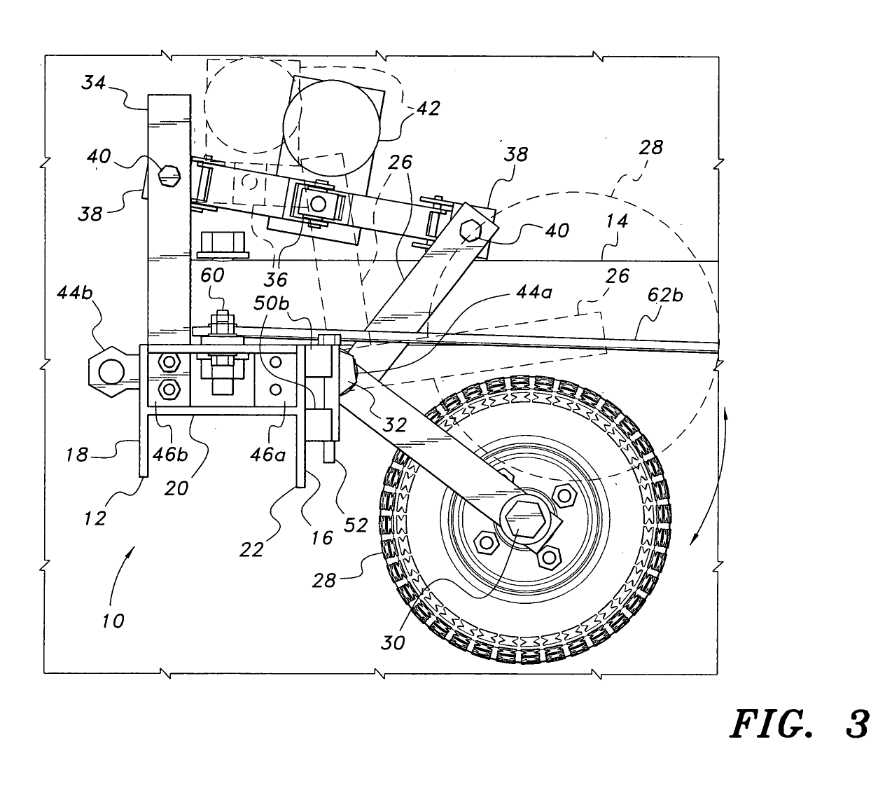

The implement 12 may comprise any of a number of different configurations. The configuration illustrated in the drawings and described herein comprises a scraper or grader formed of a length of metal having an I-beam cross section with a first flange or face 16, an opposite second flange or face 18, and a medial web 20 joining the two flanges 16 and 18. This I-beam cross-sectional configuration is most clearly illustrated in FIG. 3 of the drawings. The first flange 16 includes a lower surface contact edge 22 having a series of permanent teeth 24 cut into or otherwise integrally formed with the edge 22. The width of the lower portion of the second face or flange 18 is somewhat less than that of the first face or flange 16 so that the teeth 24 extend downwardly beyond the edge of the second face or flange 18 to engage the surface therebeneath when the wheel support carriage 26 is raised so that the implement 12 is resting upon the surface. It will be understood that other earth-shaping implements besides stationary teeth may be formed in or attached to the beam (such as a harrow, aerator, or the like), and that the beam may have a different cross-sectional shape.

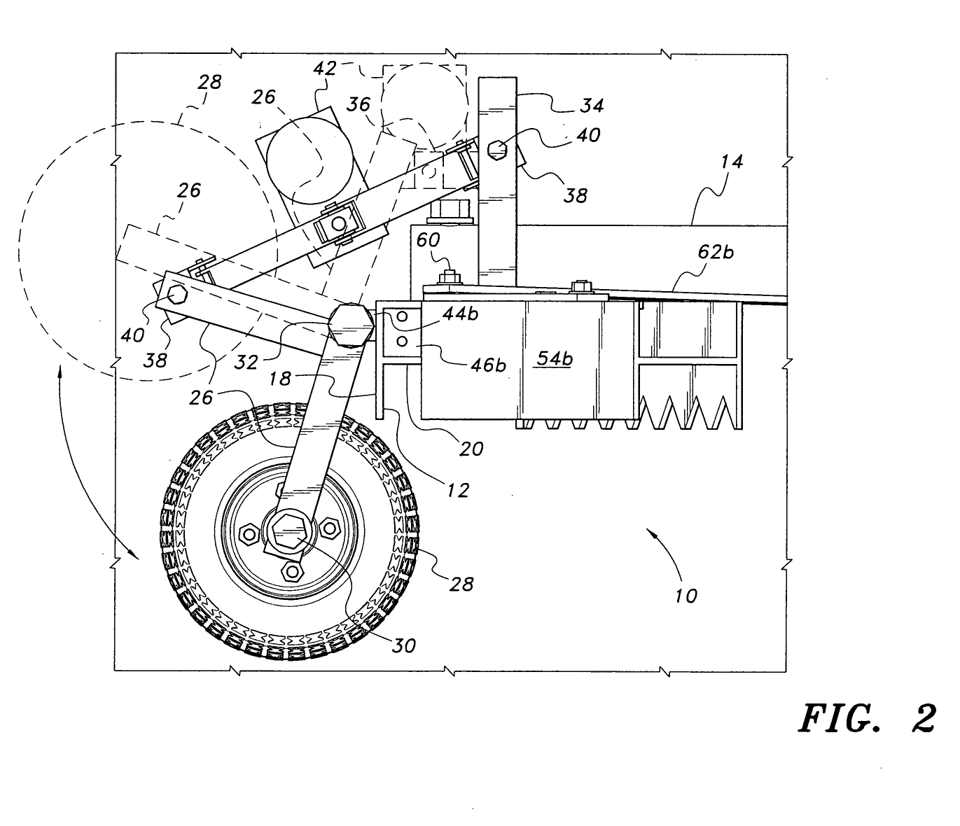

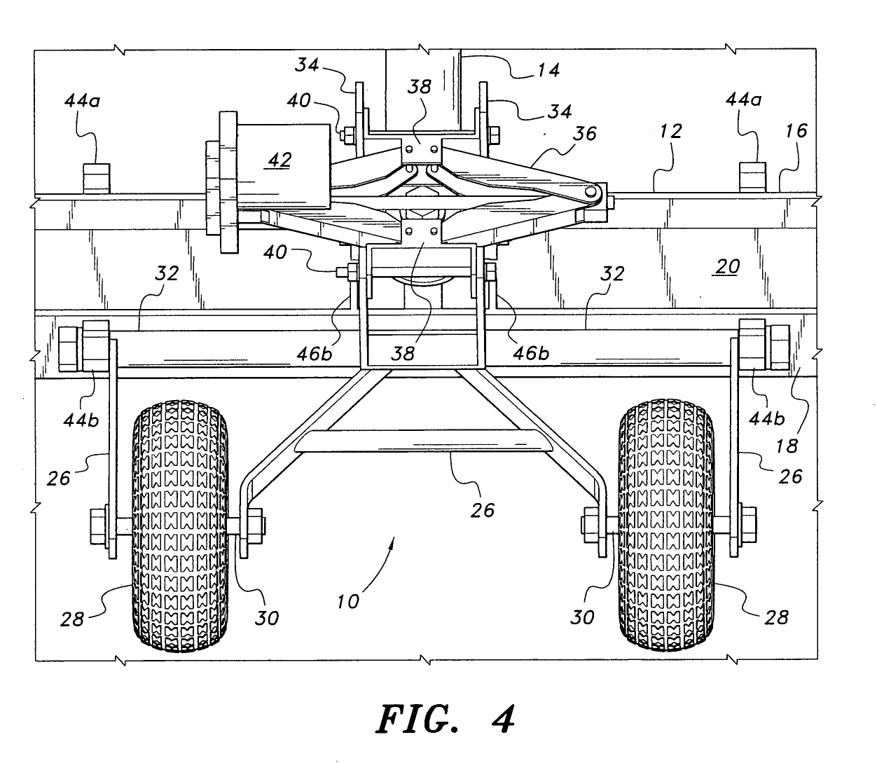

The wheel support carriage 26 extends from the earthworking implement 12, and supports a pair of wheels 28 (more clearly shown in FIG. 4) thereon. The wheel support carriage 26 is pivotally attached to the implement 12 to allow the wheels 28 to be raised or lowered relative to the implement 12 in order to raise the implement above the surface for transport or to allow the implement to rest upon the surface for earthworking. Details of the wheel attachment and support mechanism are shown in FIGS. 2 through 5. The wheel support carriage 26 comprises a pair of generally orthogonal arms, with the lower arms having first and second wheel axles 30 installed in the distal ends thereof. The opposite attachment ends of the arms are secured to the implement 12 by an elongate lateral bolt or axle 32, which pins the attachment ends of the arms pivotally to the implement 12.

A wheel adjustment bracket assembly 34 extends from the implement 12 to serve as a fixed anchor for the wheel height adjustment mechanism. The bracket assembly 34 may comprise a pair of arms immovably secured to the implement and extending upwardly therefrom. A jack 36 extends between the bracket assembly 34 and the distal ends of the upper arms of the wheel carriage assembly 26 for raising and lowering the wheels. Each end of the jack 36 has a bracket 38 permanently affixed thereto, e.g., by welding, etc., with each bracket 38 having a laterally disposed pivot bolt or pin 40 extending therethrough and pivotally connecting the bracket 38 at one end of the jack 36 to the wheel adjustment bracket assembly 34 and the bracket 38 at the opposite end of the jack 36 to the distal ends of the upper arms of the wheel carriage assembly 26.

A number of different types of wheel lifting and lowering jacks may be used in the landscaping attachment 10. The jack 36 shown in the corresponding illustrations and described herein comprises a scissors jack having a lateral actuation screw disposed medially therethrough. The jack 36 is preferably electrically actuated, with an actuation motor 42 communicating mechanically with one end of the actuation screw to rotate the actuation screw and extend or retract the jack 36, depending upon the direction of rotation of the motor and screw. The motor 42 is preferably a DC electric motor, operating nominally on about twelve to fourteen volts, or more specifically operating by electrical power provided by the towing vehicle V.

Such small towing vehicles V are not conventionally equipped with hydraulic systems to operate auxiliary equipment, but are universally equipped with conventional electrical systems to operate lights and other electrical equipment conventionally installed upon such vehicles. The landscaping attachment 10 makes use of the electrical power provided by the conventional electrical system of the vehicle V to actuate the motor 42 and extend or retract the jack mechanism 36. Conventional switching means (not shown) is used to drive the motor in the rotational direction desired from the operator's position of the vehicle V via a conventional wiring harness (not shown), to extend or retract the jack 36.

It will be seen that actuating the motor 42 will rotate the jack screw, thereby extending or retracting the jack 36 depending upon the direction of rotation of the motor 42 and screw. Retraction of the jack 36 results in drawing the upper arms of the wheel support carriage 26 toward the wheel adjustment bracket assembly 34, thus raising the wheels 28 from their lowered position (shown in solid lines in FIGS. 2 and 3) to their raised position (shown in broken lines in FIGS. 2 and 3).

More precisely, the implement 12 lowers to the underlying surface as the jack 36 contracts, with the wheels 28 being raised slightly above the underlying surface when the jack 36 is retracted or contracted completely. When the jack 36 is completely folded or retracted, as shown in broken lines in FIGS. 2 and 3, all of the weight of the implement 12, as well as the weight of the wheels 28 and wheel carriage assembly 26 and the jack 36 and motor 42, are resting on the underlying surface to provide the required force to work the surface as desired. The implement 12 is raised above the surface by reversing the jack actuation motor 42 to extend the jack 36, thereby lowering the wheels 28 and raising the teeth of the implement 12 above the surface. This is the preferred configuration for towing the attachment 10 from point to point when contact with the underlying surface (e.g., manicured lawn, pavement, etc.) is not desired.

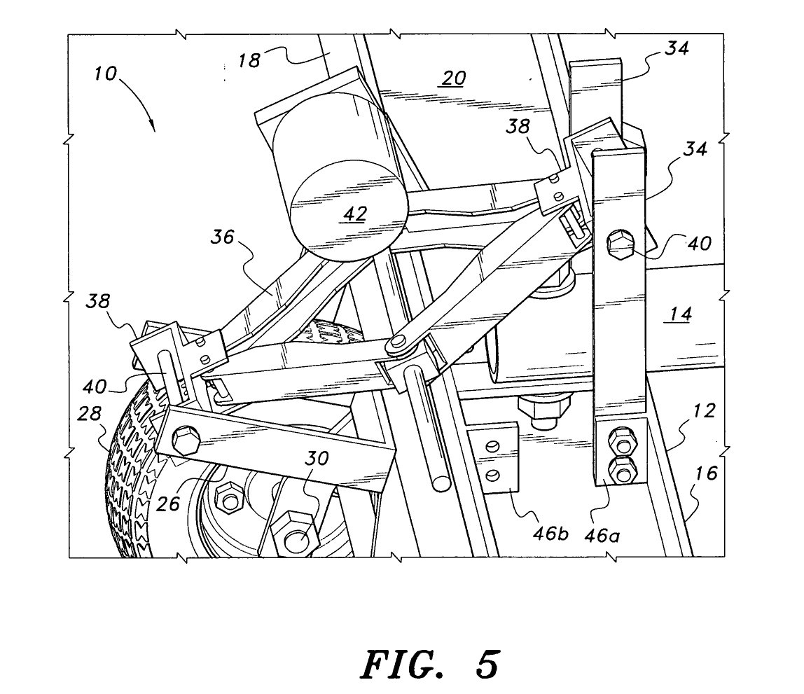

It will be noted that the wheel carriage assembly 26 is shown positioned to opposite sides of the implement in FIGS. 2 and 3. This provision permits the wheels 28 and their carriage assembly 26 to be attached either behind the implement 12, as shown in FIG. 2, for greater rearward weight shift of the assembly, or in front of the implement 12, as shown in FIG. 3, in which case the wheel tracks are erased by the following implement during operation. The implement beam 12 permits the repositioning of the wheel carriage assembly 26 by means of opposite first and second wheel adjustment pivot lug sets 44a and 44b, respectively, extending from the first and second faces or flanges 16 and 18 of the I-beam implement 12, and first and second wheel adjustment bracket lug sets, respectively 46a and 46b, extending from the first and second faces or flanges 16 and 18 of the I-beam implement 12 on the opposite sides or surfaces from the corresponding wheel adjustment pivot lug sets 44a and 44b. The wheel adjustment pivot lug sets 44a and 44b are most clearly shown in FIG. 4, with one bracket each of the two wheel adjustment bracket lug sets 46a and 46b being shown most clearly in FIG. 5.

In FIG. 2, the wheel support carriage 26 and its wheels 28 are shown to the rear of the I-beam implement 12, i.e., to the opposite side of the implement 12 from the towing tongue or arm 14. This is accomplished by installing the attachment ends of the lower arms of the wheel support carriage 26 to the second or rearward wheel adjustment pivot lugs 44b by means of the elongate pin or axle bolt 32, and installing the wheel adjustment bracket assembly 34 to the opposite, forwardly disposed wheel adjustment bracket lugs 46a (shown in FIG. 3). It will be seen that the jack 36 may remain attached to the wheel carriage assembly 26 and wheel adjustment bracket assembly 34 at all times, and need not be removed from those components when the wheel carriage assembly is moved from one side of the implement 12 to the other. However, the jack 36 may be removed from the components 26 and 34 if so desired, if such removal facilitates the installation of the carriage assembly 26 to either side of the implement 12 as desired.

In FIG. 3, the wheel carriage assembly 26 has been reinstalled to the front of the implement 12, i.e., to the same side of the implement 12 as the towing tongue or arm 14. This is accomplished by securing the attachment ends of the lower arms of the wheel carriage assembly 26 to the first or forward wheel adjustment pivot lugs 44a extending from the first or forward flange or face 16 of the implement 12 and securing the two brackets comprising the wheel adjustment bracket assembly 34 to the opposite, rearwardly-disposed second wheel adjustment bracket lugs 46b. Again, the wheel carriage assembly 26 with its wheels 28, the jack 36, and the wheel adjustment bracket assembly 34 may remain secured together as a unit during the installation of the assembly to the front or rear of the implement 12.

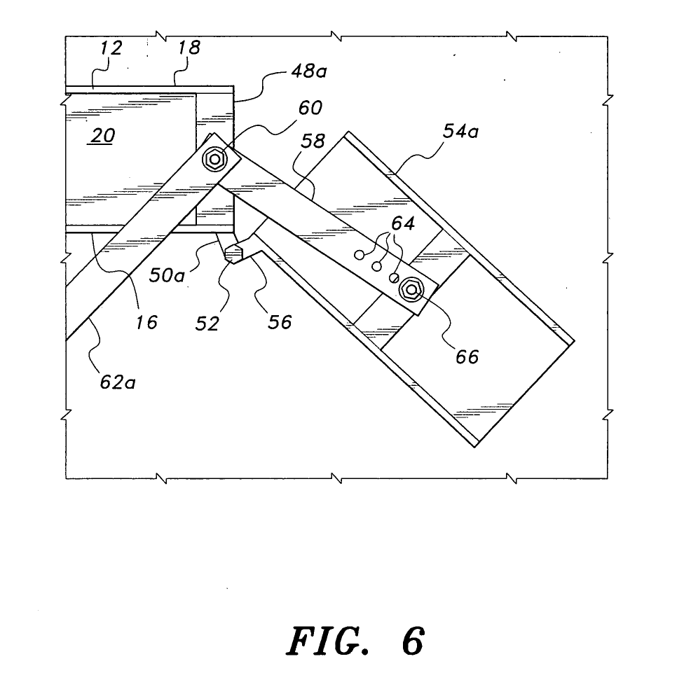

The implement 12 may also be provided with adjustable wings 54a and 54b, as shown particularly in FIGS. 1 and 6 of the drawings. The wings 54a and 54b may be removed from the implement 12 if their use is not required for the operation to be performed. The implement 12 includes laterally opposed first and second ends, respectively 48a and 48b, as shown in FIG. 1. Each of the ends has a set of wing attachment hinge lugs 50a and 50b extending forwardly therefrom, with the hinge axis (indicated by the hinge bolt or pin 52 in FIGS. 3 and 6) being normal to the plane defined by the span of the implement 12 and its towing tongue 14. A wing 54a, 54b is pivotally attached to each end 48a, 48b of the implement 12 by a cooperating hinge lug 56 extending from each wing 54a, 54b. (The second or right wing 54b is removed from its attachment to the right end of the implement 12 in the right elevation view of FIG. 3 in order to more clearly show the forward attachment of the wheel support carriage assembly 26.) The hinge bolt or pin 52 that pivotally secures each wing 54a and 54b to their respective implement ends 48a and 48b restricts angular motion of the two wings 54a and 54b to a plane parallel to the plane of the implement 12 and its tow bar or tongue 14, i.e., in a generally fore and aft horizontal arc when the implement 12 and towing tongue 14 are oriented generally horizontally.

The angular position of each wing 54a, 54b is locked in position as selected by a wing angle manual adjustment link 58, with the left side link 58 being shown in detail in FIG. 6. The base or anchor end of the link 58 is pivotally secured to the distal end of the implement 12, e.g., first or left end 48a in FIG. 6, by a bolt or pin 60 which also secures a brace 62a, 62b between the towing tongue 14 and the opposite ends 48a and 48b of the implement 12.

As the pivot axis bolt or pin 52 of the wing attachment hinge assembly is offset from the attachment of the anchor end of the adjustment link 58, it will be seen that securing the wings 54a, 54b to the implement 12 at different relative angles will result in different distal end attachment points for the corresponding links 58. Accordingly, each link 58 may be provided with a series of wing attachment passages or holes 64 in order to adjustably secure the wings 54a, 54b to the implement beam 12 at the desired angle. The wing attachment passages 64 of the links 56 may be established to set the wing angles as desired, e.g., zero degrees (in line with the implement beam 12), fifteen degrees, thirty degrees, forty five degrees, etc., as desired, and locked or secured in that selected position by a bolt or pin 66. It will also be noted that the wings 54a, 54b may be removed from their respective attachments to the ends 48a, 48b of the implement 12 merely by removing the corresponding hinge bolt or pintle 52 and disconnecting the link 58 at either its adjustment end or at its opposite anchor end.

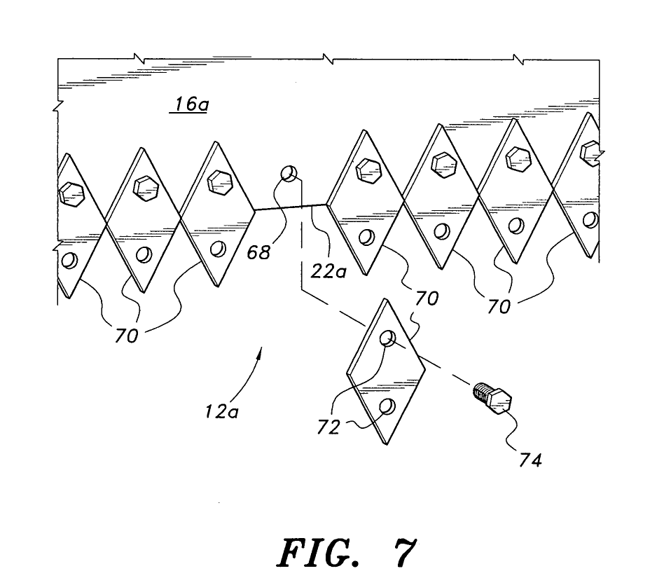

FIG. 7 provides an exploded detail perspective view of an alternate embodiment for the teeth of the implement 12. The implement teeth 24 shown in the perspective view of FIG. 1 are integral parts of the implement beam 12, with the front flange or face 16 of the beam being cut to form the teeth 24. In the embodiment of FIG. 7, the first or front flange or face 16a of the implement 12a has a series of tooth attachment holes or passages 68 formed therethrough with a smooth lower surface contact edge 22a, rather than a serrated or toothed lower edge, as in the embodiment of FIG. 1. This allows a series of separate, removable teeth 70 to be installed along the length of the implement 12a. The removable teeth 70 preferably have a rhomboid configuration with opposed attachment holes 72 therethrough in order that each tooth 70 may be reversed when excessive wear occurs to one end or the other, thereby effectively doubling the life of each tooth. The removable teeth 70 may be secured to the first face or flange 16a of the implement beam 12a by means of conventional bolts 74 and nuts (not shown), or the bolts 74 may thread into threaded tooth attachment passages 68 formed through the front flange or face 16a of the implement 12a.

In conclusion, the landscaping attachment 10 provides a much needed tool for working and clearing land for the person having access to a small all terrain vehicle, garden tractor, golf cart, or the like.

It is to be understood that the present invention is not limited to the embodiments described above, but encompasses any and all embodiments within the scope of the following claims.

I claim:

1. A landscaping attachment, comprising:
an elongate earthworking implement;
a towing tongue extending substantially medially from, and substantially normal to, the implement;
a wheel support carriage pivotally attached to the implement;
a plurality of wheels disposed upon the wheel support carriage;
a wheel adjustment bracket assembly extending from the implement;
an adjustable wheel lifting and lowering jack disposed between the wheel adjustment bracket assembly and the wheel support carriage; and
an electric motor selectively driving the jack.

2. The landscaping attachment according to claim 1, further comprising:
said implement further having a first face and a second face opposite the first face;
a first wheel adjustment pivot lug set extending from the first face of said implement;
a second wheel adjustment pivot lug set extending from the second face of said implement;
a first wheel adjustment bracket lug set extending from the first face of said implement;
a second wheel adjustment bracket lug set extending from the second face of said implement;
said wheel adjustment bracket assembly selectively secured to one of said wheel adjustment bracket lug sets; and
said wheel support carriage selectively installed upon one of said wheel adjustment pivot lug sets and to said wheel adjustment bracket assembly.

3. The landscaping attachment according to claim 1, further comprising:
said implement further having mutually opposed first and second ends;
said implement and said towing tongue defining a plane;
first and second wing attachment hinges respectively disposed upon the first and second ends of said implement, each of said hinges having a pivot axis substantially normal to the plane of said implement and said towing tongue;
first and second wings adjustably extending respectively from said first and second wing attachment hinges; and
first and second wing angle manual adjustment links respectively disposed between each of the ends of said implement and the corresponding one of said wings.

4. The landscaping attachment according to claim 1, wherein said jack is a scissor jack.

5. The landscaping attachment according to claim 1, wherein said implement comprises a scraper formed of a length of metal having an I beam cross section with a first flange, a second flange opposite the first flange, and a medial web joining the first flange and the second flange.

6. The landscaping attachment according to claim 5, wherein the first flange includes a surface contact edge having a plurality of permanent teeth formed integrally therewith.

7. The landscaping attachment according to claim 5, wherein the first flange includes a surface contact edge having a plurality of replaceable teeth removably attached thereto.

8. A landscaping attachment, comprising:
an elongate earthworking implement having a first face and a second face opposite the first face;
a towing tongue extending substantially medially from, and substantially normal to, the implement;
a first wheel adjustment pivot lug set extending from the first face of the implement;
a second wheel adjustment pivot lug set extending from the second face of the implement;
a first wheel adjustment bracket lug set extending from the first face of the implement;
a second wheel adjustment bracket lug set extending from the second face of the implement;
a wheel adjustment bracket assembly selectively secured to one of the wheel adjustment bracket lug sets;
a wheel support carriage selectively installed upon one of the wheel adjustment pivot lug sets and to the wheel adjustment bracket assembly; and
a plurality of wheels disposed upon the wheel support carriage.

9. The landscaping attachment according to claim 8, further comprising:
an adjustable wheel lifting and lowering jack disposed between said wheel adjustment bracket assembly and said wheel support carriage; and
an electric motor selectively driving said jack.

10. The landscaping attachment according to claim 8, further comprising:
said implement further having mutually opposed first and second ends;
said implement and said towing tongue defining a plane;
first and second wing attachment hinges respectively disposed upon the first and second ends of said implement, each of said hinges having a pivot axis substantially normal to the plane of said implement and said towing tongue;
first and second wings adjustably extending respectively from said first and second wing attachment hinges; and
first and second wing angle manual adjustment links respectively disposed between each of the ends of said implement and the corresponding one of said wings.

11. The landscaping attachment according to claim 8, wherein said jack is a scissor jack.

12. The landscaping attachment according to claim 8, wherein said implement comprises a scraper formed of a length of metal having an I beam cross section with a first flange, a second flange opposite the first flange, and a medial web joining the first flange and the second flange.

13. The landscaping attachment according to claim 12, wherein the first flange includes a surface contact edge having a plurality of permanent teeth formed integrally therewith.

14. The landscaping attachment according to claim 12, wherein the first flange includes a surface contact edge having a plurality of replaceable teeth removably attached thereto.

15. A landscaping attachment, comprising:
an elongate earthworking implement having mutually opposed first and second ends;
a towing tongue extending substantially medially from, and substantially normal to, the implement, the implement and the towing tongue defining a plane;
first and second wing attachment hinges respectively disposed upon the first and second ends of the implement, each of the hinges having a pivot axis substantially normal to the plane of the implement and the towing tongue;
first and second wings adjustably extending respectively from the first and second wing attachment hinges; and
first and second wing angle manual adjustment links disposed between each of the ends of the implement and a corresponding one of the wings, respectively.

16. The landscaping attachment according to claim 15, further comprising:
a wheel support carriage pivotally extending from said implement;
a plurality of wheels disposed upon said wheel support carriage;
a wheel adjustment bracket assembly extending from said implement;
an adjustable wheel lifting and lowering jack disposed between said wheel adjustment bracket assembly and said wheel support carriage; and
an electric motor selectively driving said jack.

17. The landscaping attachment according to claim 15, further comprising:
said implement further having a first face and a second face opposite the first face;
a first wheel adjustment pivot lug set extending from the first face of said implement;
a second wheel adjustment pivot lug set extending from the second face of said implement;
a first wheel adjustment bracket lug set extending from the first face of said implement;
a second wheel adjustment bracket lug set extending from the second face of said implement;
a wheel adjustment bracket assembly selectively secured to one of said wheel adjustment bracket lug sets;
a wheel support carriage selectively installed upon one of said wheel adjustment pivot lug sets and to said wheel adjustment bracket assembly; and
a plurality of wheels disposed upon said wheel support carriage.

18. The landscaping attachment according to claim 15, wherein said jack is a scissor jack.

19. The landscaping attachment according to claim 15, wherein said implement comprises an I beam having a lower front flange with a plurality of permanent teeth formed integrally therewith.

20. The landscaping attachment according to claim 15, wherein said implement comprises an I beam having a lower front flange with a plurality of replaceable teeth removably attached thereto.
